(19) United States
(12) Patent Application Publication
(10) Pub. No.: US 2002/0021793 A1
(43) Pub. Date: Feb. 21, 2002

(54) Destination unavailable state and notification service for public telephone network

(76) Inventors: Okon Shmuel, Herzeliya (IL); Reuven Tal, Kiron (IL)

Correspondence Address: DARBY & DARBY P.C., 805 Third Avenue, New York, NY, 10022, US

(21) Appl. No.: 09/930,383

(22) Filed: Aug. 14, 2001

Related U.S. Application Data
(60) Provisional application No. 60/224,772, filed on Aug. 14, 2000.

(51) Int. Cl. H04M 1/24; H04M 3/08

(52) U.S. Cl. 379/201.01; 379/32.01; 379/211.01

(57) ABSTRACT

Methods for placing and controlling an unavailable state of a destination telephone number. When in an unavailable state, callers attempting to contact a destination telephone number are provided with a prompt through to create a task that provides a notification when the connection between the calling telephone and the destination telephone is possible. Within this task, the unavailable state of the destination is tested, and if a predetermined criterion is satisfied, the notification is provided to the caller through the communication network. A connection can then be established if the caller approves. The unavailable state of a destination telephone number can be set by providing commands to a node in the communication network. The destination can be unavailable for all callers or only for specific callers. A programmed control system can be used to implement these methods.

This application claims the benefit of priority under 35 U.S.C. § 119(e) of U.S. Application Ser. No. 60/224,772, filed Aug. 14, 2000, entitled “Public Wire Telephone Network With A Destination Unavailable State And With Availability Notification Service, the entirety of which is herby incorporated by reference.

### FIELD OF THE INVENTION

This invention relates generally to communications systems and, more particularly, to a method and system for managing unavailable states in a communication system.

### BACKGROUND OF THE INVENTION

It is a common occurrence for one individual to try and call another individual on the telephone but be unable to talk to someone at a given destination. The most common situation is that there is no answer at the destination. In response, the calling party might redial the destination telephone number from time to time in hope that the receiving call party answers the call. This is a time-consuming process for the call initiator and impedes on his or her ability to make and receive other calls. Until the call is completed, there is no opportunity for the telephone service provider to derive any revenue. In many cases the party initiating the call will give up and abort after one or more redials, depending on his desires and circumstances, and this will generally cause loss of revenue to the service provider.

Various systems have been implemented to address the situation when a calling party cannot immediately reach a party at the destination telephone number. For example, some telephone service providers offer services such as a notification service wherein, when a busy signal is reached, the caller can request that the telephone system monitor the busy status of the destination and then inform the caller when the line ceases to be busy. This service, however, does not address the situation of calling a destination which is not answering.

### SUMMARY OF THE INVENTION

In accordance with one aspect of the present invention, a method for controlling an unavailable state of a destination in a communication network is described which includes the steps of providing to the telephone system a command, conveying the command to a node in the communication network, determining whether the command is an unavailable-state command, and setting the unavailable state of the destination in the communication network in response to the unavailable-state command.

In accordance with another aspect of the invention, a method for placing a destination in a telephone system in an unavailable state operates free of any manual intervention. That method includes the steps of ringing a destination telephone associated with the destination in response to a call attempt by a calling party, monitoring the call attempt for an off-hook condition at the destination telephone, and, in the absence of the off-hook condition at the destination telephone for a prescribed time period, setting the destination in the unavailable state without manual intervention.

In accordance with yet another aspect of the invention, the above mentioned method for placing a destination in an unavailable state without any manual intervention is applied individually for each caller.

In a further aspect of the invention a method for facilitating a connection between a calling telephone and a destination telephone is disclosed for use when the destination becomes available. The method operates in a communication network, and includes the steps of providing a prompt to the calling telephone through the communication network to create a task that provides a notification when the connection between the calling telephone and the destination telephone is possible. Within this task, the unavailable state of the destination is tested, and if each of the testing steps satisfies a respective predetermined criterion, notification is provided to the calling telephone through the communication network. A connection is then established to the destination in response to an approval from the calling telephone.

In yet another aspect of the invention, a system is provided for facilitating a connection between a calling telephone and a destination telephone when the destination is previously unavailable. The system comprises a control system for managing the operation of a communication network, the control system including a programmed computer which is configured to (a) provide a prompt to a calling party through the communication network to create a task that provides a notification when the connection between the calling telephone and the destination telephone is possible; (b) receive a task-creating command, and, in response to the task-creating command, test the unavailable state of the destination; (c) provide the notification to the calling telephone through the communication network if the test satisfies a predetermined criterion; and (d) establish a connection to the destination in response to an approval from the calling party.

These and other aspects, features, and advantages of the invention will be more readily apparent from the following detailed description and drawings of illustrative embodiments

### BRIEF DESCRIPTION OF THE DRAWINGS

FIG. 1 shows a high-level diagram of communication system for implementing the present invention;

FIG. 2 is a flowchart of the system setting and main call-initiating loop;

FIG. 3 is a flowchart of one method of implementing a task to connect a caller with a destination.

### DETAILED DESCRIPTION OF THE PREFERRED EMBODIMENT

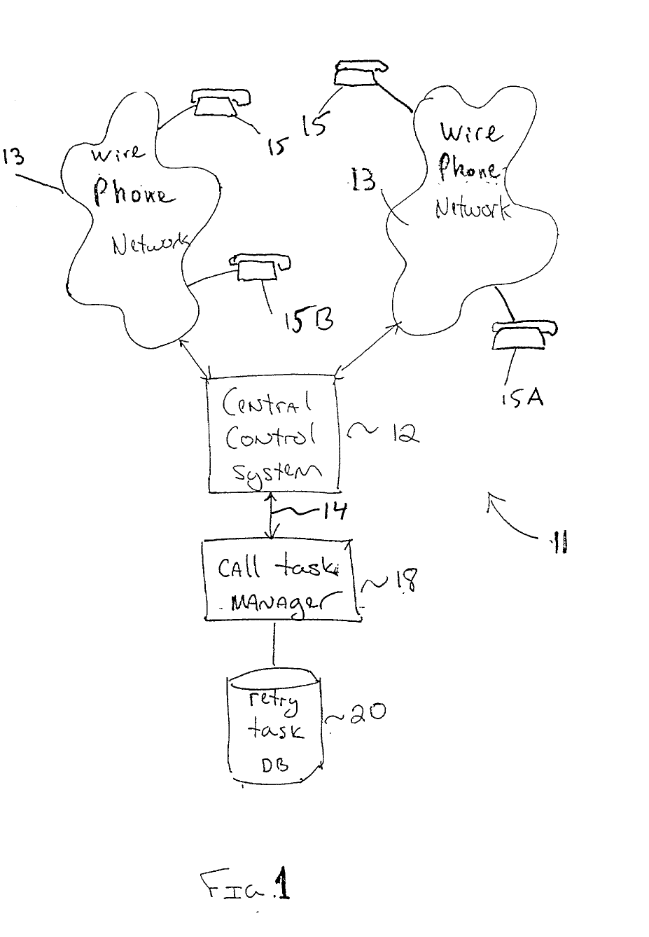

By way of overview and introduction, FIG. 1 shows a high-level diagram of communication system or network 11. The system 11 is managed by a central control system 12 which is connected to one or more wire phone networks 13 and therethrough to a plurality of wire telephones 15. The central control system also can be connected to cellular phone networks, as understood by those of skill in the art. The central control system 12 includes a programmed computer that is responsible for managing the operation of the communication system 11. Although a centralized system is illustrated, system management features can also be implemented in a distributed fashion.

Various types of derivative or add-on functionality can be added to the control system 12, such as voice-mail or messaging services. Using similar techniques known to those of skill in the art, a call task manager 18 and an associated retry task database 20 can be implemented within or added to the functionality of the central control system 12. The call task manager 18 addresses situations when a call is placed to a destination telephone number that is unavailable. As discussed in more detail below, the call task manager 18 acts as an intelligent agent for the calling party and informs the calling party when the previously unavailable destination is available to receive a call. If the present system is implemented in conjunction with a voice-mail system, preferably the caller is given the option to leave a message instead of creating a notification task.

A “telephone number,” as used in the phrases “destination telephone number” and “call-origination telephone number,” refers to a number assigned to a subscriber which, when addressed by a telephone company switch or similar hardware, causes something to happen at one or more particular telephones (for example, sets connected to that telephone line or sets assigned to that number by a call forwarding operation) or directs a calling party to a specified voice mail account. Thus, as is conventional today, a telephone number does not address only a particular set of telephones but permits reprogramming as desired.

A “destination” is an abbreviated reference to “destination telephone number,” and is not restricted to a particular telephone such as a destination telephone 15B. Multiple telephones 15 can be associated with a destination telephone number. Each destination telephone is “associated” with a destination telephone number in that a call to a given destination telephone number can be answered at any associated destination telephone.

The term “ringing” refers a call attempt in which a calling telephone 15A attempts to connect to a destination telephone 15B through the communication network. At present, the most common ringing signal is an alternating current from a central office along a local loop to the destination telephone, but other forms of ringing signals can be used depending on the telephone system being used.

When the destination telephone 15B goes “off-hook,” the call is complete, with the parties at both ends (namely, at telephone sets 15A and 15B) able to converse with one another.

In general, when the caller tries to reach a destination and the destination is unavailable, the call task manager 18 initiates a task, upon the direction of the caller, which monitors the state of both the destination telephone number and the call-origination telephone number, and informs the calling party when the destination is available to receive a call. The monitoring step includes determining if either party is busy and determining if both parties are available to receive calls within the network. Only when the call origin and destination are each not busy and available is an attempt made to connect the two parties with each other.

As noted above, the call task manager monitors party states to determine if a telephone number is busy or unavailable. The call task manager 18 has access to the resources of the central control system 12 through data link 14. Thus, calls placed through the central control system 12 can be automatically monitored.

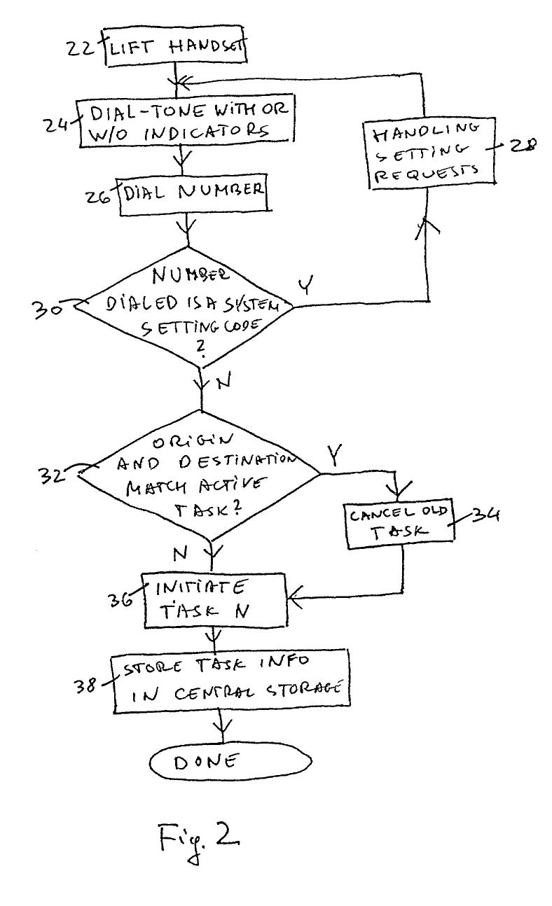

Turning to FIG. 2, a process flow of a preferred embodiment is described. There is shown a principal call-initiating loop that executes within the central control system 12 and/or the call task manager 18. When a user of a wire phone lifts the handset of a telephone (step 22), he hears a dial tone (step 24). If the telephone number is set to unavailable state and/or there are notification requests pending, special dial tones indicating such state will be heard (or otherwise indicated). At this time the user can key in numbers at the telephone 15A (step 26).

The unavailable state does not affect outgoing calls. A caller to an unavailable destination can be provided with a special response that indicates that the destination is in an unavailable state. If a particular destination is set in an unavailable state, any notifications requested at that telephone can be indicated either by a special dial tone when lifting the handset, by some other indicator, or a combination of these approaches.

Depending on the numbers keyed in by the user, a call will be made to a destination telephone number or a user command will be processed. By entering a command, as tested at step 30, the user can change the system settings, such as altering the setting of the availability state between available and unavailable (or unavailable set and reset), can review and modify pending notification requests (block 28), and can revert to a dialing that differs from the tone heard at step 24. The test at step 30 can be performed at the central control system 12 or task manager 18.

If the number entered at step 26 is not recognized as being one of the system setting codes, as tested at step 30, then a call task is initiated to connect the caller to the destination that was addressed by the numbers entered at step 26. Information needed to identify the task, such as the number associated with calling telephone 15A, the number associated with telephone 15B, and a task ID are stored in the central storage or task database (step 38).

Many such tasks are typically performed in parallel to several destinations and from several callers to the same destination. If a particular destination is not available, that assigned task will remain active until the call is completed, the task is aborted (by the caller), or a timer has run out. In the preferred embodiment, upon receipt of a proposed call from call-origination telephone number to a destination telephone number, the system 11 determines at step 32 whether the caller and destination already match a currently pending task, or, in other words, determines whether the system is already trying to connect that caller to that destination. If the calling party has dialed the number of a currently pending task, this manual retry can be used as a command to cancel the prior task, as shown at step 34, and optionally to initiate a new task, as shown at step 36. In this arrangement, a caller who previously attempted to reach a specific unavailable destination and has requested the system to inform him or her when the destination is available cancels that request simply by redialing the destination telephone number.

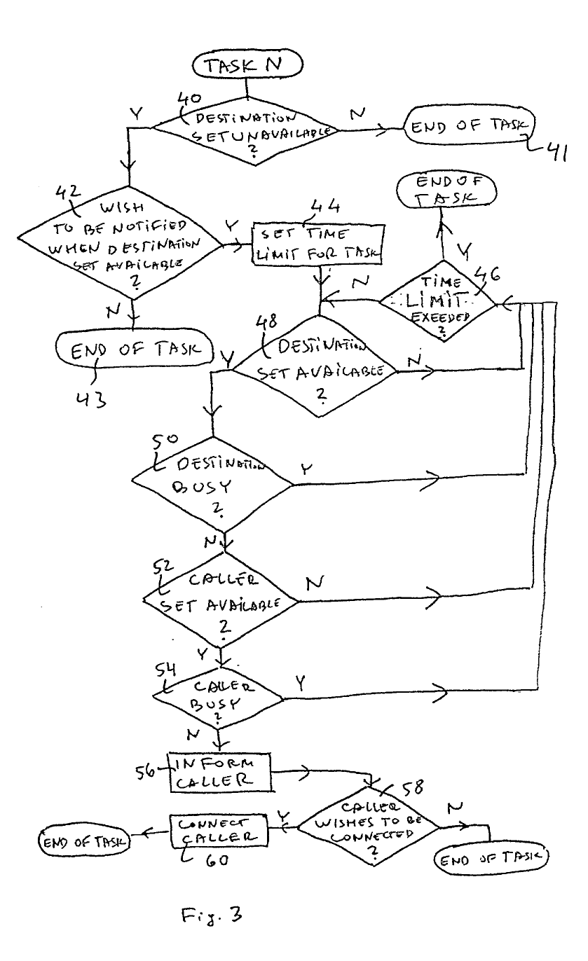

FIG. 3 is a flowchart of one method for implementing a task to connect the calling telephone 15A with the destination telephone 15B. The task tries to connect the call as per normal operating procedures for the network. Initially, a determination is made whether the destination is in an unavailable state (step 40), either by manual setting or by an automatic setting, as described below. If the test determines “NO,” the destination is available, then the task is terminated at step 41.

If the test determines “YES,” then the destination is not available and the caller is preferably given the option to request that the task monitor the destination and inform the caller when the destination is available (step 42). If the caller does not want the system to provide such a notification, the task can be terminated, as indicated at step 43. Otherwise, the caller can input a time limit for the task to repeat attempts to make the connection according to his preference (step 44). Alternatively, the task can be assigned a default time period after which it will automatically terminate. In addition, various user specified parameters can be received, such as a priority relative to other tasks assigned to the same calling telephone 15A and a specified task lifetime. If tasks from multiple calling telephones are attempting to reach the same destination, the system can assign a relative priority among those tasks. The caller can also be informed of this condition and, given priority state relative to tasks from other callers, optionally for a fee.

While the task continues to run, provided that the time limit is not exceeded (step 46), the central control system 12, or call task manager 18 repeatedly checks whether the destination has become available (step 48). This state can be managed central control system 12 or task manager 18, for example, by programming or erasing a bit associated in a memory with each telephone number that is managed by the call task manager 18. If NO, the task will loop until the destination is set available. When destination is set available, however, it is checked whether the destination is busy (step 50), that is, whether the line is in use which can be readily determined in a conventional manner. If YES, the task will loop and again confirm the available state of the destination as well as whether it is busy (steps 48 and 50). If NO, it is not busy, the task then checks the status of the call-origination telephone number. At step 52, a test is made to see if the call-origination telephone number is available. If NO, the task loops as described above. If YES, it is checked whether the call-origination telephone number is busy (step 54). If YES, the task will loop. If it is not busy, only then does the system inform the calling party that the call can be connected to the destination (step 56) and, upon the caller's approval (step 58), a connection is established between the caller and the destination (step 60). If the caller does not approve, the task ends. The task can loop back to step 46 to repeat the tests at steps 48-54 if the a prescribed period of time has not been exceeded.

Different loops and tests can be performed to establish that both the calling party and the destination party are available and not busy. For example, the loop, counters, and delays described in connection with FIG. 4 of co-pending U.S. application Ser. No. 09/595,274, filed Jun. 15, 2000, entitled “Method And System For Notifying A Caller That A Cellular Phone Destinations Is Available” can be utilized in an embodiment that practices the methods of the present invention, and that patent application is incorporated herein by reference as if set forth in its entirety herein.

In the event that the destination becomes busy or is set to the unavailable state prior to the calling party approving to make a connection to that destination, the notification can be canceled, extinguished or otherwise removed so that the caller does not receive an outdated notification.

A destination can be automatically set into an unavailable state at the level of the central control system 12 if a caller attempts to reach the destination 15B yet there is no answer after a specified time or in view of some other prescribed criterion. Alternatively, the destination can be set as unavailable individually for each caller, for example, by associating a call-origination telephone number with an unavailable state setting for a given destination. Any call attempt to that destination can then be treated as reaching an unavailable destination, as described above, and the caller can be prompted as indicated at step 42 of FIG. 3 to initiate the advisory service described above.

An unavailable state can be canceled by an action taken by the called party. For example, lifting a handset of a destination telephone after the destination had been set automatically into unavailable condition can be the user action required to reset the unavailable condition.

The invention in one of its modes permits a destination to be set in an unavailable state that has advantages over presently existing “privacy” efforts. For example, by unplugging a phone, no incoming calls can get through, and no outgoing calls can be made. Turning off the ringer of a wire phone set has the same effects and the same disadvantages as unplugging, except the ability to make outgoing calls. When lifting the handset to make an outgoing call while the ringer is off, a destination that is unwilling to take incoming calls might unintentionally answer an incoming call that was ringing at the same time. In either case, however, the caller gets the same response as with a phone plugged in and with the ringer on. On the other hand, by providing an unavailable state setting, exceptions can be made for privileged incoming calls (e.g., from identified calling telephones 15A) which can get through, such as wake-up calls, calls of special authorization, emergency calls and notifications that were requested from a telephone set to unavailable mode. Optionally, there can be one or more privileged levels, set at the discretion of the destination. In one of the levels, any call defined as urgent by the caller will be considered as privileged and therefore will get through.

Multiple phone numbers on one line can be treated collectively or independently as far as the unavailable status is managed.

Several persons at a destination, such as members of a family, can have individual ID's that can be individually set to unavailable on the basis of the ID. If such setting has been made and a call reaches such destination, the caller is preferably prompted to enter an ID according to the person of his choice (or an “I don't care” ID).

The inventive system and method are applicable for other types of cable or wireless (such as cellular) phone systems of the type in which the central control system has essentially continuous information of the availability of individual phones.

The inventive method is of benefit for the destination, due to the convenience in avoiding incoming calls placed at times when he was unavailable or unwilling to answer and shifting them to a time he sets his phone to be available. The inventive method is of benefit for the caller because he will get the destination at the earliest time when it becomes available without redialing again and again. The inventive method is of benefit to the network operators, as (a) it eliminates the load that would be otherwise generated by futile redials, without any revenue, and (b) calls that might otherwise be lost can take place.

The inventive system and method are applicable for a cable or wireless (such as cellular) phone system of the type in which the central control system has essentially continuous information of the availability of individual destinations.

We claim:

1. A method for controlling an unavailable state of a destination in a communication network, comprising the steps of:
(a) providing to the telephone system a command;
(b) conveying the command to a node in the communication network;
(c) determining whether the command is an unavailable-state command; and
(d) controlling the unavailable state of the destination in the communication network in response to the unavailable-state command.

2. The method of claim 1, wherein the prescribed time period is measured on the basis of the ringing signal provided to a destination telephone associated with the destination.

3. The method of claim 1, including the additional step of providing a prompt to the caller through the communication network to create a task that provides a notification when the destination is reset from the unavailable state to an available state.

4. The method as in claim 1, wherein the step of controlling the unavailable state of the destination is performed by a switch at a central office.

5. The method as in claim 1, wherein steps (a) through (d) are performed by a switch at a central office.

6. The method as in claim 1, wherein the step of controlling the unavailable state of the destination comprises setting the destination in the unavailable state.

7. The method as in claim 1, wherein the step of controlling the unavailable state of the destination comprises resetting the destination to the available state.

8. The method as in claim 1, wherein the controlling step comprises one of setting and resetting a bit in a memory of the node.

9. A method for placing a destination in a telephone system in an unavailable state, comprising the steps of:
(a) ringing a destination telephone associated with the destination in response to a call attempt by a calling party;
(b) monitoring the call attempt for an off-hook condition at the destination telephone; and
(c) in the absence of the off-hook condition at the destination telephone for a prescribed time period, setting the destination in the unavailable state without manual intervention.

10. The method of claim 9, wherein the prescribed time period is measured on the basis of the ringing signal provided to the destination telephone associated with the destination.

11. The method of claim 9, including the additional step of providing a prompt to the caller through the telephone system to create a task that provides a notification when the destination is reset from the unavailable state to an available state.

12. The method as in claim 9, wherein the step of setting the destination in the unavailable state is performed by a switch at a central office.

13. The method as in claim 9, wherein steps (a) through (c) are performed by a switch at a central office.

14. The method as in claim 9, including the additional step of resetting the destination to an available state by taking the destination telephone associated with the destination off-hook.

15. The method as in claim 14, wherein taking the destination telephone off-hook comprises lifting the handset.

16. The method as in claim 9, wherein the setting step comprises an operation on a bit in a memory.

17. A method for placing a destination in a telephone system in an unavailable state with respect to an individual caller, comprising the steps of:
(a) ringing a destination telephone associated with the destination in response to a call attempt by a calling party;
(b) monitoring the call attempt for an off-hook condition at the destination telephone; and
(c) in the absence of the off-hook condition at the destination telephone for a prescribed time period, setting the destination as unavailable with respect to the individual caller.

18. The method of claim 17, wherein the prescribed time period is measured on the basis of the ringing signal provided to the destination telephone associated with the destination.

19. The method of claim 17, including the additional step of providing a prompt to the caller through the telephone system to create a task that provides a notification when the destination is reset from being unavailable to being available.

20. The method as in claim 17, wherein the step of setting the destination as unavailable is performed by a switch at a central office.

21. The method as in claim 17, wherein steps (a) through (c) are performed by a switch at a central office.

22. The method as in claim 17, including the additional step of resetting the destination to available for the individual caller by taking the destination telephone associated with the destination off-hook

23. The method as in claim 22, wherein taking the destination telephone off-hook comprises lifting the handset.

24. The method as in claim 17, wherein the setting step comprises an operation on a bit in a memory.

25. In a communication network, a method for facilitating a connection between a calling telephone and a destination telephone when a destination is initially in an unavailable state, comprising the steps of:
(a) providing a prompt to the calling telephone through the communication network to create a task that provides a notification when the connection between the calling telephone and the destination telephone is possible;
(b) in response to receiving a task-creating command,
(1) testing the unavailable state of the destination;
(2) testing the busy state of the destination;
(c) if each of the testing steps satisfies a respective predetermined criterion, providing the notification to the calling telephone through the communication network; and
(d) establishing the connection to the destination in response to an approval from the calling telephone.

26. The method of claim 25, wherein the predetermined criterion for the unavailable state test is that a bit associated with the destination is either set or reset.

27. The method of claim 25, wherein steps (b) and (c) are repeated for a prescribed period of time.

28. The method of claim 25, wherein the notification to the calling telephone is continuously updated until the task is terminated.

29. The method of claim 25, wherein step (b) includes the additional steps of testing the unavailable state of a call-origination telephone number and testing the busy state of the call-originatation telephone number.

30. The method of claim 25, including the additional step of terminating the task if the calling telephone attempts the connection to the destination telephone while the task is still active.

31. A system for facilitating a connection between a calling telephone and a destination telephone when a destination is previously in an unavailable state, comprising:
a control system for managing the operation of a communication network, the control system including a programmed computer configured to:
(i) provide a prompt to a calling party through the communication network to create a task that provides a notification when the connection between the calling telephone and the destination telephone is possible;
(ii) receive a task-creating command, and, in response to the task-creating command:
(1) test the unavailable state of the destination;
(iii) provide the notification to the calling party through the communication network if the test satisfies a predetermined criterion; and
(iv) establish the connection to the destination in response to an approval from the calling party.

32. The system of claim 31, wherein the programmed computer is additionally configured to test the busy state of the destination.

33. The system of claim 32, wherein the programmed computer repeatedly tests the unavailable state and the busy state of the destination over a prescribed period of time unless a respective predetermined criterion is satisfied earlier.

34. The system of claim 32, wherein the programmed computer is additionally configured to test the unavailable state of a call-origination telephone number and the busy state of the call-origination telephone number.

35. The system of claim 34, wherein the programmed computer repeatedly tests the unavailable state and the busy state of the destination and the call-origination telephone number over a prescribed period of time unless the predetermined criterion is satisfied earlier.

36. The system of claim 31, wherein the programmed computer terminates the task if the calling telephone attempts to make the connection to the destination telephone through the communication network while the task is still active.
